(19) United States
(12) Patent Application Publication
(10) Pub. No.: US 2015/0241021 A1
(43) Pub. Date: Aug. 27, 2015

(54) LED Lensing Arrangement

(71) Applicant: Cree, Inc., Durham, NC (US)

(72) Inventors: Kurt Wilcox, Libertyville, IL (US); Craig Raleigh, Burlington, WI (US); Mario Alberto Castillo, Racine, WI (US)

(73) Assignee: Cree, Inc., Durham, NC (US)

(21) Appl. No.: 14/638,242

(22) Filed: Mar. 4, 2015

Related U.S. Application Data
(63) Continuation-in-part of application No. 13/843,928, filed on Mar. 15, 2013.
Application No. 13/843,928 is a continuation-in-part of application No. 14/462,426, filed on Aug. 18, 2014.
Application No. 14/462,426 is a continuation-in-part of application No. 14/462,391, filed on Aug. 18, 2014.
Application No. 14/462,426 is a continuation-in-part of application No. 13/842,521, filed on Mar. 15, 2013.
Application No. 14/462,391 is a continuation-in-part of application No. 13/842,521, filed on Mar. 15, 2013.
(60) Provisional application No. 62/005,955, filed on May 30, 2014.
(60) Provisional application No. 62/009,039, filed on Jun. 6, 2014.

(51) Int. Cl. F21V 5/04; F21K 99/00

(52) U.S. Cl. CPC F21V 5/04; F21K 9/50; F21Y 2101/02

(57) ABSTRACT

An LED lensing arrangement for lighting fixtures includes (1) a rigid light-transmissive outer structure having an outwardly-facing light-exit surface and an outer-structure light-input surface, (2) an optically-clear molded polymeric inner structure having a light-entrance surface and a light-output surface which is adhered to the outer-structure light-input surface, the inner structure being of a material which is pourable upon molding, one example being a liquid silicone rubber (LSR) material, and (3) at least one LED light source secured with respect to and optically coupled to the inner-structure light-entrance surface.

### RELATED APPLICATIONS

This application is a continuation-in-part of patent application Ser. No. 13/843,928, filed Mar. 15, 2013. This application is also a continuation-in-part of patent application Ser. Nos. 14/462,426 and 14/462,391, both filed Aug. 18, 2014, each of which in turn is a continuation-in-part of application Ser. No. 13/842,521, filed Mar. 15, 2013. This application is also based in part on Provisional Application Ser. No. 62/055,955, filed May 30, 2014, and on Provisional Application Ser. No. 62/009,039, filed Jun. 6, 2014. The contents of each of such applications are incorporated herein by reference in their entirety.

### FIELD OF THE INVENTION

The invention relates generally to the field of LED lighting systems and, more particularly, relates to the lensing structures which are used with LED light sources in LED lighting fixtures.

### BACKGROUND OF THE INVENTION

There is a need for lighting apparatus for a variety of general lighting purposes which is low-cost and energy-efficient. In the field of lighting, many different types of light sources have been developed. Recently, LED light sources involving multi-LED arrays, each with a large number of LED packages, have been developed as a means of bringing the many advantages of LED lighting—LED efficiency and long life—into the general illumination field. In particular, such LED light fixtures have been developed for use in outdoor settings, including by way of example lighting for parking lots, roadways, display areas and other large areas.

LED light sources are energy-efficient, and advances in LED technology are providing even greater efficiencies over time. One important aspect of LED light fixtures is the so-called secondary lensing that directs light received from LED light sources. Secondary lenses, which receive and direct light from LED light sources, are of significant importance to LED light fixtures in many ways.

Secondary lenses play a major role, of course, in the direction of light from a light fixture, and so determine the degree, spread and orientation of illumination, and overall optical efficiency. The forming and shaping of secondary lenses are typically important considerations with respect to the usefulness of an LED fixture and play a significant role in overall product cost. Improvements in secondary lenses, their optical capabilities, and their manufacture are important considerations in the field of LED light fixtures.

LED light fixtures for a wide variety of both specific and general lighting applications typically have a plurality of LED light sources, usually positioned in spaced relationship to one another on a board (e.g., a circuit board), and a secondary lens is aligned with each LED light source. One such configuration is disclosed in copending U.S. patent application Ser. No. 13/843,928 (Raleigh et al.), titled “Multi-layer Polymeric Lens and Unitary Optic Member for LED light Fixtures and Method of Manufacture.” Such document discloses a unitary optic member for directing light from a plurality of LED light sources on a board beneath the optic member, the optic member having a plurality of lens portions surrounded by and interconnected by a non-lens portion. The optic member of such document includes a first molded polymeric layer forming the non-lens portion and an outermost layer of each of the lens portions, and a second molded polymeric layer overmolded onto the first polymeric layer within pocket-spaces corresponding to each lens portion. One aspect of the invention disclosed in such document is a multi-layer polymeric lens for directing light from an LED light source, the lens defining a lens optical footprint and at least one of the polymeric layers being less than coextensive with the footprint.

As LED lighting becomes more widespread within the lighting marketplace, there is a continuing need to simplify manufacturing and reduce the number of components within LED light fixtures and fixture components. One way to simplify manufacturing and reduce cost and components is to combine the functions of two or more components into a single component. Another is to utilize materials in a way which takes advantage of the best attributes of each material while at the same time eliminating their less-desirable properties. The present invention utilizes such combination of functions and best attributes to provide a unique LED lensing arrangement for lighting fixtures.

It is an object of the present invention to provide an LED lensing arrangement which combines the best attributes of (1) rigid light-transmissive materials such as optical-grade thermoplastic or glass and (2) less rigid optically-clear polymeric materials, such as liquid silicone rubber (LSR), which are pourable and of low enough viscosity upon formation to allow for specific detailed lens-portion shapes that are maintained during product usage despite the presence of heat and moisture.

Stated differently, it is an object of the invention to provide a multi-material LED lensing arrangement which avoids some of the disadvantages of certain materials when used separately, and to provide an LED lensing arrangement that is moldable in a wide variety of shapes for a wide variety of light-directing purposes. Other objects include to reduce cycle times in the component manufacture, to increase dimensional replication of such components, to increase optical efficiency, to increase photometric accuracy, to increase production throughout rates, and to lower overall cost.

These and other objects of the invention will be apparent from the following descriptions and from the drawings.

### SUMMARY OF THE INVENTION

The invention is an LED lensing arrangement for lighting fixtures. The inventive lensing arrangement comprises: (1) a rigid light-transmissive outer structure which has an outwardly-facing light-exit surface and an outer-structure light-input surface; (2) an optically-clear molded polymeric inner structure which has a light-entrance surface and an light-output surface adhered to, and in some cases substantially coextensive with, the outer-structure light-input surface, the inner structure being of a material which is pourable upon molding; and (3) at least one LED light source secured with respect to and optically coupled to the inner-structure light-entrance surface.

The rigid outer structure may be of a rigid light-transmissive polymeric material, an example of which is polymethyl methacrylate (PMMA), or it may be of glass.

As for the optically-clear molded polymeric inner structure, the words “upon molding” used in the phrase “pourable upon molding” in describing such material refers to the condition of the material as it enters the mold which determines its shape. The polymeric material used for the optically-clear inner structure can be described as being of low viscosity upon molding; more specifically, the viscosity upon molding is less than about 10,000 centipoise, and in certain embodiments less than about 5,000 centipoise. The optically-clear inner structure may be of an elastomeric material.

In certain embodiments, including those detailed later herein, the optically-clear inner structure is a liquid silicone rubber (LSR) member. The LSR member may be of an optical-grade LSR, or of another LSR, typically less expensive, which is sufficiently optically clear for lighting-fixture purposes. The inner structure may have a Shore A durometer hardness of less than about 70. Examples of suitable LSRs that may be used in this invention are mentioned below.

The term “optically-clear” as used with respect to the molded inner structure of the LED lensing arrangement of this invention means that the material, once formed, allows passage of light sufficient to efficiently satisfy the requirement for commercial lighting fixtures. The term “optical-grade,” is a subset of the term “optically-clear”; “optically-clear” does not necessarily imply “optical-grade.”

In many embodiments, the inventive LED lensing arrangement has a plurality of LED light sources along the light-entrance surface of the inner structure. In some of such embodiments, including some described herein, the plurality of LED light sources are arranged substantially along a single line.

In certain embodiments of the inventive LED lensing arrangement, the outer-structure light-input surface and the outwardly-facing light-exit surface are in non-parallel planes, and in some of these embodiments, the outer-structure light-input surface and the outwardly-facing light-exit surface are in substantially perpendicular planes.

In certain specific embodiments of the inventive LED lensing arrangement, the outer structure is a sheet-like member having two principal surfaces and the outer-structure light-input surface, one of the principal surfaces being the outwardly-facing light-exit surface and the other being a light-extraction surface configured to reflect light from the at least one LED light source outward through the outwardly-facing light-exit surface. In certain of such embodiments, the light-extraction surface includes a plurality of angled surfaces.

In certain other embodiments of the inventive LED lensing arrangement, the two principal surfaces are angled to one another such that the outer structure has a wedge-like cross-section in a plane perpendicular to the exit and input surfaces of the outer structure.

In some specific embodiments, the outer-structure light-input surface and the inner-structure light-output surface are planar. This planar-surface-on-planar surface arrangement can be in various configurations and relationships of outer structure and inner structure.

In certain specific embodiments, the outer structure is a sheet-like member having two principal surfaces, one of the two principal surfaces being the outwardly-facing light-exit surface and the other being the outer-structure light-input surface, and the inner-structure light-output surface engages at least a portion of such the outer-structure light-input surface, and in some cases a major portion of the outer-structure light-input surface. The term “major portion,” as used herein in referring to the extent of engagement of the inner structure light-output surface with the outer-structure light-input surface when such light-input surface is one of the two principal surfaces of the outer structure, means that the cross-dimensions of the area of surface-to-surface engagement of the inner-structure light-output surface and outer-structure light-input surface constitutes more than half the corresponding cross-dimension of the outer structure (i.e., along the same line).

In certain of such embodiments, the outer-structure light-exit surface is substantially planar, and in certain of these embodiments the outer-structure light-input surface is also substantially planar. In such situations, the outer structure is a flat sheet, which may be a glass sheet or may be of a light-transmissive rigid polymeric sheet, such as PMMA.

In certain of such embodiments, the optically-clear molded polymeric inner structure, in addition to having the light-output surface, has its light-entrance surface along a light-entrance edge of the inner structure, such light-entrance edge being shaped to receive the at least one LED light source, and, opposite the light-output surface, such inner structure also has a surface with molded light-extraction characteristics specifically configured to direct light from the light-entrance surface to and through the outer structure. Such inner structure may be a liquid silicone rubber (LSR) member, as discussed above.

Another aspect of this invention is an LED lighting fixture including an LED lensing arrangement as described above.

The term “LED light source” as used herein refers to an LED or a small grouping of LEDs, either alone or more typically, a small grouping of LEDs in what is referred to as an LED package. LED light sources typically have a primary lens formed thereon.

The term “sheet-like member having two principal surfaces,” as used herein with respect to certain examples of a rigid light-transmissive outer structure, means that the member has two outer opposed surfaces that are large compared to its other outer surfaces, which are edges and/or ends of the outer structure.

The term “light-extraction surface,” as used herein, refers to a particular configuration of a surface of a light-transmissive structure. Such surface is configured to have a plurality of ridges or other surface features such that light which has entered such structure at an edge thereof and proceeds from there along the subject surface encounters such ridges or other surface features and is thereby redirected out of such light-transmissive structure in a generally intended direction. Two sorts of light-extraction surfaces are seen in examples of this invention described herein. In one case, the light-extraction surface is a surface of the rigid light-transmissive outer structure, and in the other it is a surface of the optically-clear molded polymeric (e.g., LSR) inner structure.

In the example in which the light-extraction surface is a surface of the rigid outer structure, one of the two principal surfaces of the rigid structure as mentioned above is an outwardly-facing light-exit surface and the other is the light-extraction surface. And, when light enters the outer structure through the outer-structure light-input surface (which is an edge of the outer structure extending between its principal surfaces) and proceeds therefrom along the light-extraction surface, much of this light is redirected by the light-extraction surface to exit the outer structure of the LED lensing arrangement though the outwardly-facing light-exit surface.

In the example in which the light-extraction surface is a surface of the molded polymeric inner structure (e.g., a structure which is of LSR), the principal surface of the rigid outer structure which is opposite the outwardly-facing light-exit surface of such outer structure is the outer-structure light-input surface, and this outer-structure light-input surface has the inner-structure light-output surface engaging at least a portion of it, often a major portion of it. In such situations, the inner structure has the its light-entrance surface along what can be referred to as a light-entrance edge of the inner structure, and the surface of the inner structure opposite the inner-structure light-output surface is the light-extraction surface. When light enters the LSR or other molded polymeric inner structure through the light-entrance edge thereof and proceeds therefrom along the light-extraction surface, much of this light is redirected by the light-extraction surface to exit the inner structure and pass through the rigid outer structure of the LED lensing arrangement of this invention.

In descriptions of this invention, including in the claims below, the terms “comprising,” “including” and “having” (each in their various forms) and the term “with” are each to be understood as being open-ended, rather than limiting, terms.

### BRIEF DESCRIPTION OF THE DRAWINGS

FIG. 1 is a partially broken-away isometric view of an LED lensing arrangement in accordance with an embodiment of this invention for use in lighting fixtures.

FIG. 2 is an enlarged left end elevation of the LED lensing arrangement of FIG. 1.

FIG. 3 is a exploded isometric view of the LED lensing arrangement of FIG. 1, but taken from a different angle than is seen FIG. 1, so that the opposite face of the rigid light-transmissive outer structure is seen.

FIG. 4 is an enlarged right-end elevation of the device as seen in FIG. 3, exploded as in such figure.

FIG. 5 is an enlarged fragmentary side view of the light-transmissive inner structure of such LED lensing arrangement, such inner structure being of liquid silicone rubber (LSR).

FIG. 6 is a further-enlarged sectional view, without cross-hatching, of the inner structure, taken along section 6-6 as shown in FIG. 5.

FIG. 7 is a less-enlarged sectional view, without cross-hatching, of the circuit board and an LED light source thereon in its light-transmitting relationship to the light-transmissive inner structure.

FIG. 8 is a schematic sectional view, without full cross-hatching, of a portion of a lighting fixture using the subject LED lensing arrangement, particularly showing how the positional relationship of the circuit board and the LED light sources thereon is maintained with respect to the rigid light-transmissive outer structure and the light-transmissive LSR inner structure thereon.

FIG. 9 is a partially broken-away side sectional view, without cross-hatching, of the LED lensing arrangement illustrated in FIGS. 1-8, providing a ray trace serving to illustrate light movement into, within, and out of the LED lensing arrangement.

FIG. 10 is an inside face view of another embodiment of the LED lensing arrangement of this invention.

FIG. 11 is an inside face view of still another embodiment.

FIG. 12 is a right-side elevation of the device of FIG. 11.

FIG. 12A is a fragmentary magnified view of an edge portion of the device as in FIG. 12, as indicated by magnification marking 12A in FIG. 12.

### DETAILED DESCRIPTION OF CERTAIN EMBODIMENTS

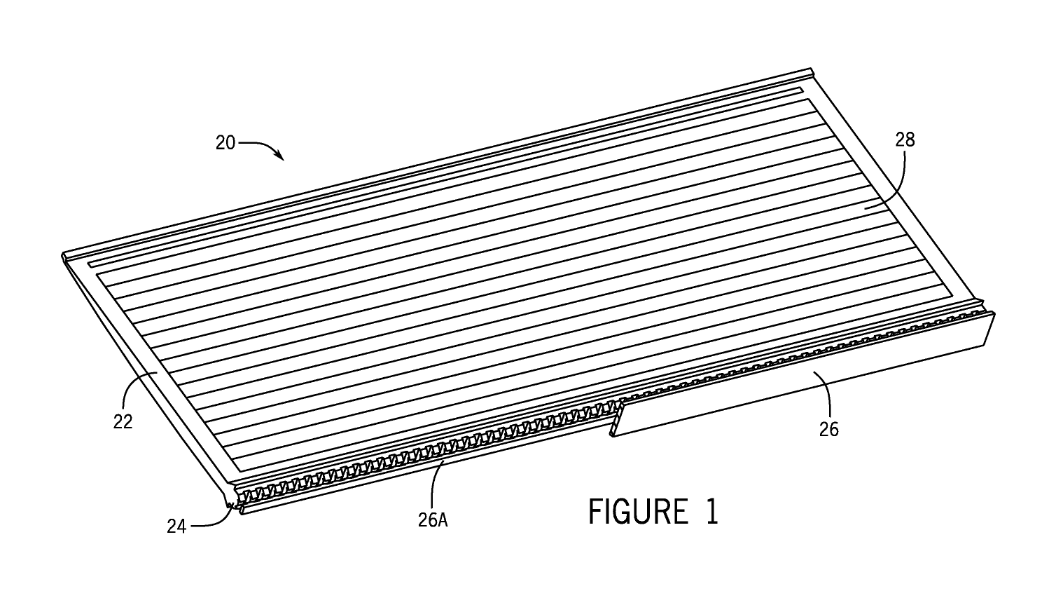

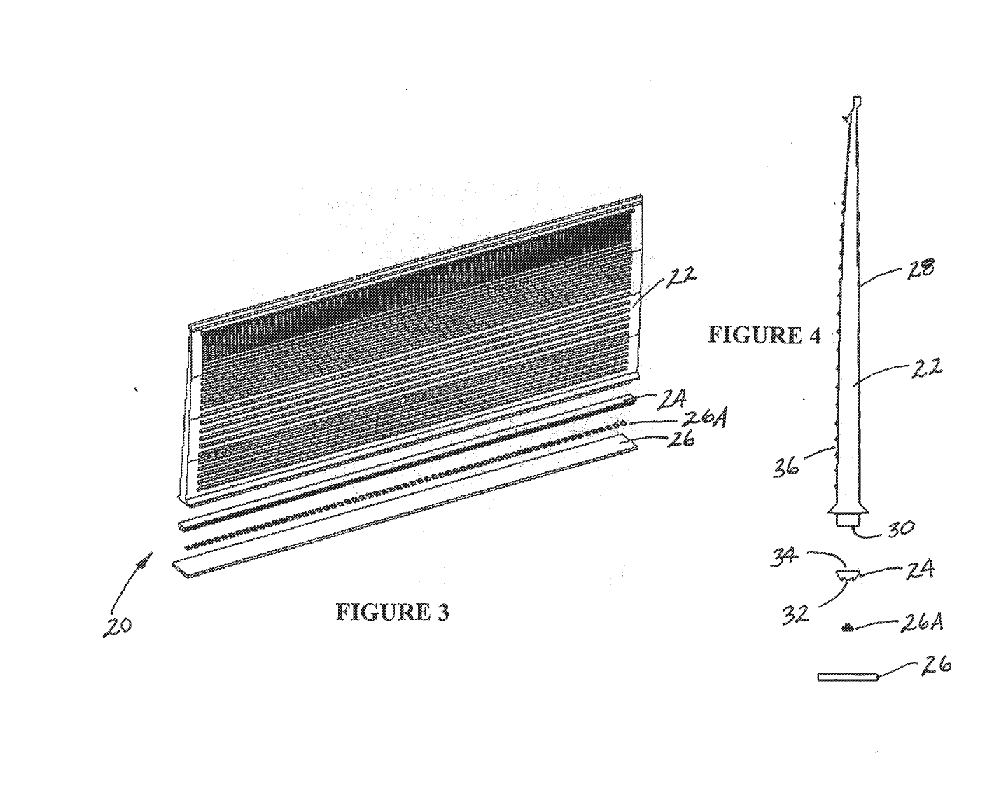

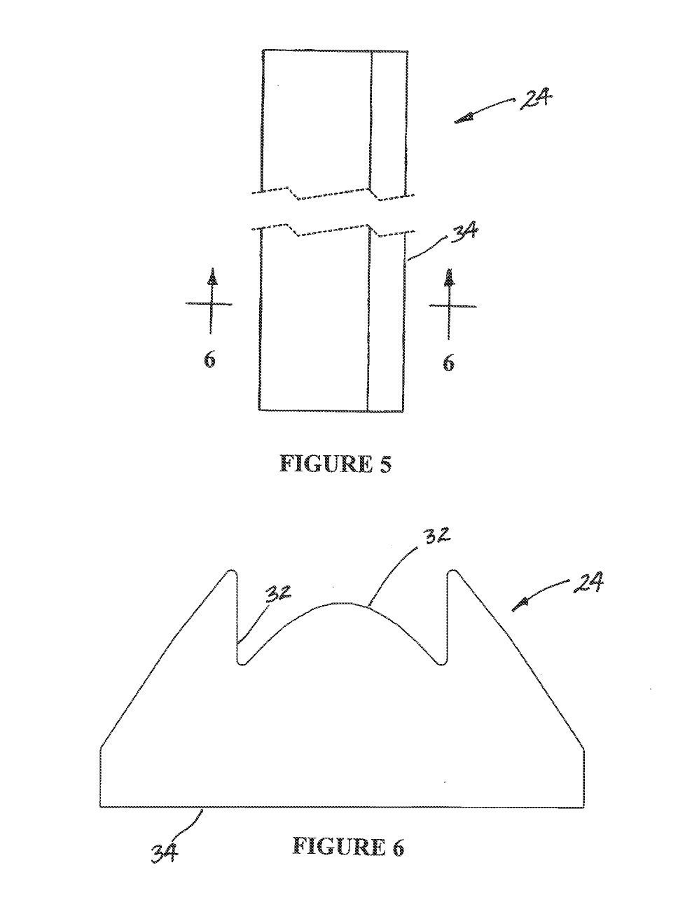

FIGS. 1-9 illustrate an LED lensing arrangement 20 for lighting fixtures which is one embodiment of this invention. Lensing arrangement 20 includes a rigid light-transmissive outer structure 22, an optically-clear molded polymeric inner structure 24, which is injection molded liquid silicone rubber (LSR), secured with respect to rigid outer structure 22, and a narrow elongate circuit board 26 having a row of LED light sources 26A thereon which are aligned with and adjacent to LSR inner structure 24.

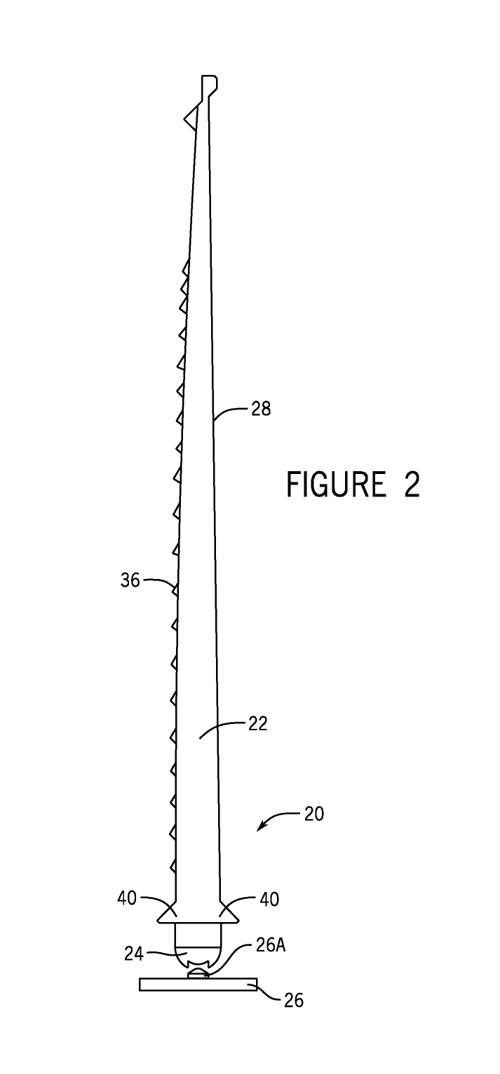

As shown best in FIGS. 2 and 4, rigid outer structure 22 has an outwardly-facing light-exit surface 28, which is one of the two opposed principal surfaces (faces) of rigid outer structure 22, and an outer-structure light-input surface 30, which is along one of the edges of rigid outer structure 22. In the embodiment shown in FIGS. 1-9, outer-structure light-input surface 30 extends between the two principal surfaces of rigid outer structure 22. Thus, outer-structure light-input surface 30 and outer-structure light-exit surface 28 are in non-parallel planes; such planes are substantially perpendicular to one another.

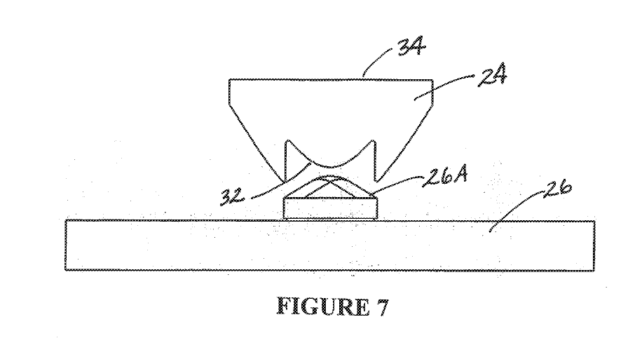

As shown best in FIGS. 6-8, LSR inner structure 24 has a light-entrance surface 32 which is adjacent to LED light sources 26A on circuit board 26, and an inner-structure light-output surface 34 which is adhered to and substantially coextensive with light-input surface 30 of rigid outer structure 22. As seen best in FIGS. 7-9, LED light sources 26A are optically coupled with light-entrance surface 32 of inner structure 24. Light-output surface 34 of inner structure 24 and light-input surface 30 of rigid outer structure 22 are both planar, and may be adhered to one another by an acceptable optical-adhesive material (not shown).

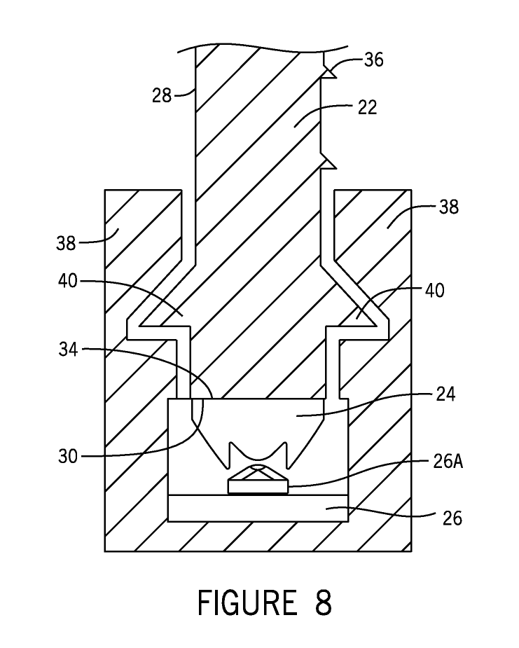

As shown in FIG. 8, elongate circuit board 26, which bears the row of LED light sources 26A, is secured to rigid outer structure 22 by means of an elongate holding member 38 which engages circuit board 26 and extends on either side of LSR inner structure 24 to engage a pair of elongate flanges 40 of rigid outer structure 22. The parts and pieces are configured to establish the intended positions of outer and inner structures 22 and 24. By this means, LED light sources 26A are secured with respect to light-entrance surface 32 of inner structure 24, slightly spaced therefrom, to maximize the intended optical coupling.

In the embodiment of FIGS. 1-9, rigid outer structure 22 is a sheet-like member which, as noted above, has two opposed principal surfaces. One of these is outer-structure light-exit surface 28, mentioned above, and the other is a light-extraction surface 36 of rigid outer structure 22. Light-extraction surface 36 of outer structure 22 is configured to redirect (by reflection) light, i.e., light that has come from LED light sources 26A, through inner structure 24, into outer-structure light-input surface 30 and from there generally along light-extraction surface 36, outwardly through outer-structure light-exit surface 28. In this manner light exits LED lensing arrangement 20 in intended directions.

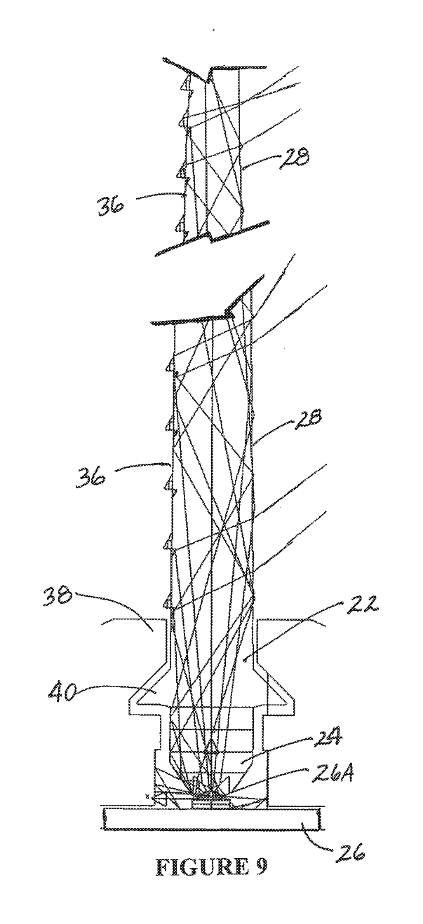

As can be seen best in the cross-section ray-trace view of FIG. 9, light-extraction surface 36 in the embodiment illustrated in FIGS. 1-9 includes a plurality of angled surfaces (ridges) oriented to reflect light coming from outer-structure light-input surface 30 in a direction toward light-exit surface 28. The ray trace of FIG. 9 shows how there is considerable reflection occurring along the light-movement length of outer structure 22, including total internal reflection (TIR) causing light to progress along outer structure 22 and reflection causing light to pass through outer-structure light-exit surface 28 to an intended target area. FIG. 9 also illustrates the passage of light into and out of inner structure 24.

The specific configuration utilized will be determined by, among other things, the light-directing characteristics desired for a light fixture using this aspect of the invention. Light-exit surface 28 of rigid light-transmissive outer structure 22 may in certain applications be facing downward when LED lensing arrangement 10 is used in a lighting fixture for lighting on streets, roadways, or other horizontal surfaces below the lighting fixture.

Rigid outer structure 22 may be made of a variety of rigid polymeric materials formed in any of known plastic forming methods. One particularly useful polymeric material is polymethyl methacrylate (PMMA), which has suitable qualities for use in this invention. Other suitable polymeric materials for rigid outer structure 22 would be well known to those skilled in the lensing art. Alternatively, the rigid outer structure may be glass formed to the desired shape. In some situations, rigid outer structure 22 may be substantially planar. In such situations, the outer structure is a flat sheet, which may be a glass sheet or may be of a light-transmissive rigid polymeric sheet.

As indicated above, the optically-clear molded polymeric inner structure, which is of a material which is pourable upon molding (or, described differently, is of a sufficiently low viscosity upon molding), may be of a elastomeric material such as liquid silicone rubber (LSR). Such LSR member may have a Shore A durometer of less than about 70. So-called optical-grade LSRs may be used, but other optically-clear LSRs may be used.

Examples of acceptable LSR materials include: EI-1164 liquid silicone rubber from Dow Corning and Elastosil® RT 601 A/B liquid silicone rubber from Wacker Silicones. Such Dow Corning LSR is pourable upon molding, having a viscosity of 4600 and when formed having a Shore A durometer hardness of 64. The Wacker LSR is pourable upon molding, having a viscosity of 3500 at 23° C., and when formed having a Shore A durometer hardness of 45. A variety of other LSR materials would also be acceptable for use in this invention.

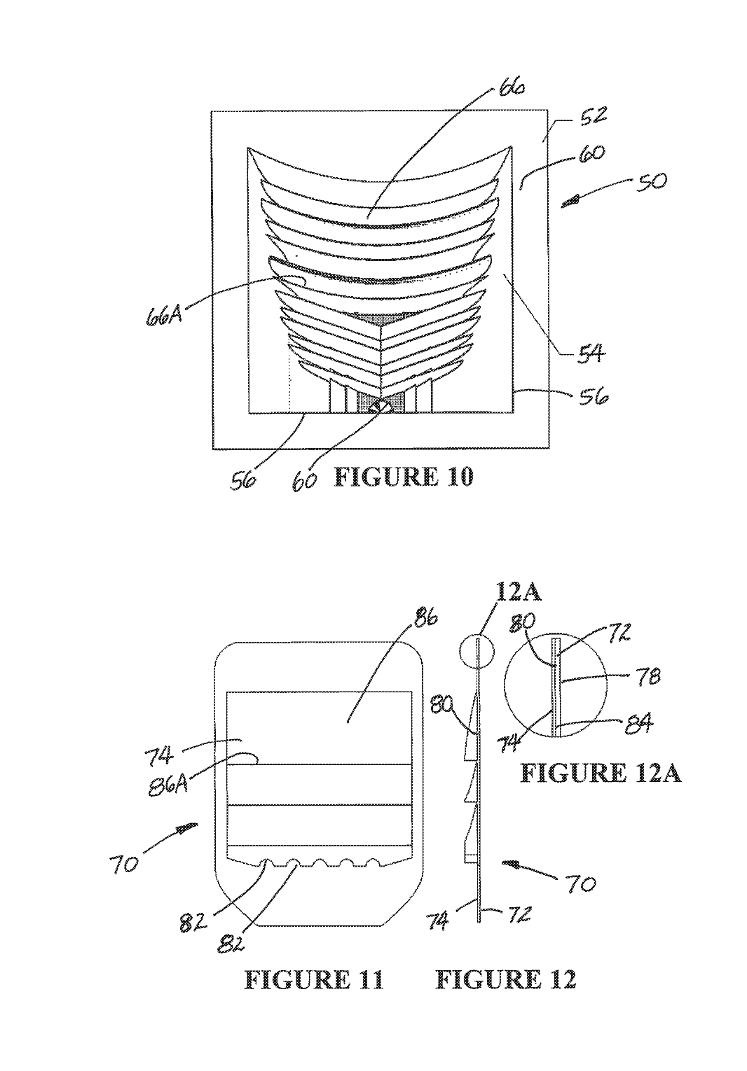

FIG. 10 illustrates an LED lensing arrangement 70 which is another embodiment of this invention, and FIGS. 11, 12 and 12A illustrate an LED lensing arrangement 70 which is still another embodiment. Lensing arrangements 50 and 70 have proportionally greater areas of surface-to-surface engagement of their respective inner-structure light-output surfaces with their respective outer-structure light-input surfaces. The optically-clear molded polymeric inner structures of such embodiments may be formed of LSR. And, each of inner structures of lensing arrangements 50 and 70 has its light-entrance surface along a light-entrance edge of the inner structure, such light-entrance edges being shaped to receive one or more LED light source; and, opposite its light-output surface, each such inner structure also has a surface with molded light-extraction characteristics specifically configured to redirect light from the light-entrance surface to and through the respective outer structure.

These additional embodiments will now be described in more detail.

Lensing arrangement 50 of FIG. 10 includes a rigid outer structure 52 and an LSR inner structure 54. Rigid outer structure 52 is a flat sheet which projects beyond the edges 56 of LSR inner structure 54. Rigid outer structure 52 may be of a rigid polymeric materials such as PMMA or may be glass.

Rigid outer structure 52 has two planar surfaces, one of which is the outer-structure light-exit surface (not seen because it is the back surface of outer structure 52 in the figure) and the other of which is the opposite surface, referred to herein as outer-structure light-input surface 60. As can be seen in FIG. 10, outer-structure surface 60 includes a portion projecting beyond edges 56 of inner structure 54 as well as the remaining portion which is behind LSR inner structure 54, and which therefore is the portion (not directly seen) of outer-structure surface 60 through which light from inner-structure light-output surface (also not directly seen) passes into outer-structure light-input surface 60. As can be seen in FIG. 10, in LED lensing arrangement 50 the inner-structure light-output surface engages a major portion of the outer-structure light-input surface.

Outer-structure light-input surface 60 is engaged by the inner-structure light-output surface (not directly seen). The flat surfaces of rigid outer structure 52 and LSR inner structure 54 are adhered to one another. The corresponding flat surfaces of the inner and outer structures may be adhered using a suitable optical adhesive, such as an index-matched adhesive, or primer. Surface-to-surface adhesion of such lensing structures may be facilitated by surface etching that tends to increase the engagement of the inner-structure material with the outer surface material.

As seen in FIG. 10, LSR inner structure 54 of LED lensing arrangement 50 includes a light-entrance surface 62 along an edge thereof through which light from an LED light source (not shown) enters inner structure 54. Optically-clear molded-LSR inner structure 54 also includes, opposite its light-output surface (not shown), a light-extraction surface 66 having molded light-extraction ridges 66A specifically configured to redirect light from light-entrance surface 62 to and through rigid outer structure 52.

Turning now to LED lensing arrangement 70 which is illustrated in FIGS. 11, 12 and 12A and has some similarity to LED lensing arrangement 50, lensing arrangement 70 includes a rigid outer structure 72 and an LSR inner structure 74. As in LED lensing arrangement 50, rigid outer structure 72 is a flat sheet and may be of a rigid polymeric materials such as PMMA or may be glass. However, unlike in LED lensing arrangement 50, LSR inner structure 74 has an inner-structure light-output surface 84 which is coextensive with outer-structure light-input surface 80; in other words, surface 84 is engaged with a major portion of surface 80, in this case all of surface 80. This is seen in FIG. 12A.

As seen in FIG. 11, LSR inner structure 74 of LED lensing arrangement 70 includes a light-entrance surface 82 along a projecting edge thereof through which light from plural LED light sources (not shown) enters LSR inner structure 74. As shown in FIGS. 11 and 12 and also with reference to FIG. 12A, LSR inner structure 74 also includes, opposite light-output surface 84, a light-extraction surface 86 which has molded light-extraction ridges 86A configured to redirect light from light-entrance surface 82 to and through rigid outer structure 72, such that light exits outer-structure light-exit surface 78 of LED lensing arrangement 70 to the intended target area.

While the principles of this invention have been described in connection with specific embodiments, it should be understood clearly that these descriptions are made only by way of example and are not intended to limit the scope of the invention.

1. An LED lensing arrangement for lighting fixtures comprising:
a rigid light-transmissive outer structure having an outwardly-facing light-exit surface and an outer-structure light-input surface;
an optically-clear molded polymeric inner structure having a light-entrance surface and a light-output surface adhered to the outer-structure light-input surface, the inner structure being of a material which is pourable upon molding; and
at least one LED light source secured with respect to and optically coupled to the inner-structure light-entrance surface.

2. The LED lensing arrangement of claim 1 having a plurality of LED light sources.

3. The LED lensing arrangement of claim 1 wherein the outer-structure light-input surface and the outwardly-facing light-exit surface are in non-parallel planes.

4. The LED lensing arrangement of claim 3 wherein the outer-structure light-input surface and the outwardly-facing light-exit surface are in substantially perpendicular planes.

5. The LED lensing arrangement of claim 4 wherein the outer structure is a sheet-like member having two principal surfaces and the outer-structure light-input surface, one of the two principal surfaces being the outwardly-facing light-exit surface and the other being a light-extraction surface configured to reflect light from the at least one LED light source outward through the outwardly-facing light-exit surface.

6. The LED lensing arrangement of claim 5 having a plurality of LED light sources along the light-entrance surface.

7. The LED lensing arrangement of claim 6 wherein the plurality of LED light sources are arranged substantially along a single line.

8. The LED lensing arrangement of claim 5 wherein the light-extraction surface includes a plurality of angled surfaces.

9. The LED lensing arrangement of claim 5 wherein the two principal surfaces are angled to one another such that the outer structure has a wedge-like cross-section in a plane perpendicular to the exit and input surfaces of the outer structure.

10. The LED lensing arrangement of claim 1 wherein the outer-structure light-input surface and the inner-structure light-output surface are planar.

11. The LED lensing arrangement of claim 1 wherein the inner-structure light-output surface is substantially coextensive with the outer-structure light-input surface.

12. The LED lensing arrangement of claim 1 wherein the inner structure is of an elastomeric material.

13. The LED lensing arrangement of claim 12 wherein the inner structure is a liquid silicone rubber (LSR) member.

14. The LED lensing arrangement of claim 13 wherein the LSR is an optical-grade LSR.

15. The LED lensing arrangement of claim 13 wherein the LSR member has a Shore A durometer hardness of less than about 70.

16. The LED lensing arrangement of claim 13 having a plurality of LED light sources.

17. The LED lensing arrangement of claim 13 wherein the outer-structure light-input surface and the outwardly-facing light-exit surface are in non-parallel planes.

18. The LED lensing arrangement of claim 17 wherein the outer-structure light-input surface and the outwardly-facing light-exit surface are in substantially perpendicular planes.

19. The LED lensing arrangement of claim 18 wherein the outer structure is a sheet-like member having two principal surfaces and the outer-structure light-input surface, one of the two principal surfaces being the outwardly-facing light-exit surface and the other being a light-extraction surface configured to reflect light from the at least one LED light source outward through the outwardly-facing light-exit surface.

20. The LED lensing arrangement of claim 19 having a plurality of LED light sources along the inner-structure light-entrance surface.

21. The LED lensing arrangement of claim 20 wherein the plurality of LED light sources are arranged substantially along a single line.

22. The LED lensing arrangement of claim 19 wherein light-extraction surface includes a plurality of angled surfaces.

23. The LED lensing arrangement of claim 19 wherein the two principal surfaces are angled to one another such that the outer structure has a wedge-like cross-section in a plane perpendicular to the exit and input surfaces of the outer structure.

24. The LED lensing arrangement of claim 13 wherein the outer-structure light-input surface and the inner-structure light-output surface are planar.

25. The LED lensing arrangement of claim 13 wherein the inner-surface light-output surface is substantially coextensive with the outer-structure light-input surface.

26. The LED lensing arrangement of claim 1 wherein:
the outer structure is a sheet-like member having two principal surfaces, one of the two principal surfaces being the outwardly-facing light-exit surface and the other being the outer-structure light-input surface; and
the inner-structure light-output surface engages at least a portion of the outer-structure light-input surface.

27. The LED lensing arrangement of claim 26 wherein the outer-structure light-exit surface is substantially planar.

28. The LED lensing arrangement of claim 27 wherein the outer-structure light-input surface is substantially planar.

29. The LED lensing arrangement of claim 28 wherein the outer structure is a glass sheet.

30. The LED lensing arrangement of claim 26 wherein the inner structure, in addition to having the light-output surface, comprises:
the light-entrance surface being along a light-entrance edge shaped to receive the at least one LED light source; and
opposite the light-output surface, a surface with molded light-extraction characteristics configured to direct light from the light-entrance surface to and through the outer structure.

31. The LED lensing arrangement of claim 30 wherein the outer structure is a glass sheet.

32. The LED lensing arrangement of claim 31 wherein the inner structure is of an elastomeric material.

33. The LED lensing arrangement of claim 32 wherein the inner structure is a liquid silicone rubber (LSR) member.

34. The LED lensing arrangement of claim 33 wherein the LSR is an optical-grade LSR.

35. The LED lensing arrangement of claim 33 wherein the LSR member has a Shore A durometer hardness of less than about 70.

36. The LED lensing arrangement of claim 26 wherein the inner-structure light-output surface engages a major portion of the outer-structure light-input surface.

37. The LED lensing arrangement of claim 36 wherein the inner structure, in addition to having the light-output surface, comprises:
the light-entrance surface being along a light-entrance edge configured to receive light from the at least one LED light source; and
opposite the light-output surface, a surface with molded light-extraction characteristics configured to direct light from the light-entrance surface to and through the outer structure.

38. An LED lensing arrangement for lighting fixtures comprising:
a rigid light-transmissive outer structure having an outwardly-facing light-exit surface and an outer-structure light-input surface;
an optically-clear molded polymeric inner structure having a light-entrance surface and a light-output surface adhered to the outer-structure light-input surface, the inner structure being of a material having a viscosity less than about 10,000 centipoise upon molding; and
at least one LED light source secured with respect to and optically coupled to the inner-structure light-entrance surface.

39. The LED lensing arrangement of claim 38 wherein the inner structure is a liquid silicone rubber (LSR) member.

40. The LED lensing arrangement of claim 39 wherein LSR has a viscosity less than about 5,000 centipoise upon molding.

41. The LED lensing arrangement of claim 40 wherein the LSR member has a Shore A durometer hardness of less than about 70.
